(19) United States
(12) Patent Application Publication
(10) Pub. No.: US 2012/0267310 A1
(43) Pub. Date: Oct. 25, 2012

(54) E-BEAM TECHNOLOGY FOR WATER TREATMENT

(76) Inventors: David M. POLIZZOTTI, Trevose, PA (US); Michael Salerno, Trevose, PA (US)

(21) Appl. No.: 13/091,397

(22) Filed: Apr. 21, 2011

(51) Int. Cl. B01D 15/00

(52) U.S. Cl. 210/663

(57) ABSTRACT

The present invention concerns a method of using Electron-beam technology to remove recalcitrant organic matter and/or volatile organic compounds from a target water sample or other fluid samples. A fluid is directed into a first vessel; and a beam of electrons from an electron beam generator is used to irradiate the fluid. Specifically, once the water is loaded into a first vessel and the organic contaminants are absorbed to saturation levels, a control sensor initiates influent water to be directed to a second vessel while the first vessel is isolated and desorbed using an energy means such as heat or microwave. The desorbed materials are directed through a common manifold containing an E-beam. The E-beam is then used to destroy organic matter desorbed from the first vessel. VOCs may be treated in this way as well, or they may be treated directly without first sorbing and desorbing prior to irradiation.

### BACKGROUND OF THE INVENTION

1. Field of the Invention

This invention is related to the removal of recalcitrant organic matter and/or volatile organic components from water or other fluids.

2. Description of Related Art

Recalcitrant organic matter in industrial wastewater typically comprises, but is not limited to, polyaromatic hydrocarbons, anilines, acrylonitrile, glycol alkyl ethers, oils, tertiary aliphatic alcohols and phenols which are difficult to remove. Additionally, remediation of volatile organic chemicals (VOC) presents similar challenges as shown by the recalcitrant organic substances and these chemicals are not easily removed from the environment as well. For example, conventional treatment processes include chemical precipitation via inorganic coagulants and/or polymer coagulants, biotreatment (which cannot degrade recalcitrant organics), flotation using zeolites, surfactants and polymers, nanofiltration (NF), reverse osmosis (RO) and membrane bioreactor (MBR) (which is the same as biotreatment with respect to degradation of recalcitrant organics). All of these methods are of limited value in terms of efficiency or cost-effectiveness.

Further, phase separation technologies have also been used for recalcitrant remediation. For example, activated carbon and/or the use of functionalized media have either been shown to be expensive and/or have limited capacity for removal. Solvent extraction is a useful method, but it is expensive, as is distillation. Other methods used to deal with recalcitrant organics include oxidation technologies. For example, oxidation via ozone, peroxides, halides, UV photo-enhanced and electro-oxidation have been evaluated. In each case, the solution is either too costly, or not effective. This includes wet air oxidation which while effective is every expensive, and requires high organic concentrations.

Accordingly, the above removal methods generally either have poor efficiency, or are very expensive. Additionally, these methods often cannot degrade recalcitrant organics or have limited capacity for removal.

Thus, there exists a strong need for a method of removing recalcitrant organic matter from water that is both cost effective and highly efficient, especially when used by itself or in combination with one of the technologies describe above and which also has the ability to treat volatile organic components.

### SUMMARY OF THE INVENTION

The present invention concerns a method of using Electron-beam technology (or E-beam technology) to remove recalcitrant organic matter and/or volatile organic compounds from a target water sample or other fluid samples. A fluid bearing organic moieties of interest is directed into a first vessel; and a beam of electrons from an electron beam generator is then used to irradiate the fluid, prior to being vented to the atmosphere.

In some embodiments, organic moieties present in the water may be first sorbed and subsequently desorbed via an energy means, and then destroyed via the E-beam. Specifically, once the water is loaded into a first vessel and the organic contaminants are absorbed to saturation levels, a control sensor initiates influent water to be directed to a second vessel while the first vessel is isolated and desorbed using an energy means such as heat or microwave. The desorbed materials are directed through a common manifold containing an E-beam. The E-beam is then used to destroy organic matter desorbed from the first vessel. VOCs may be treated in this way as well, or they may be treated directly without first sorbing and desorbing prior to irradiation.

The present invention and its advantages over the prior art will become apparent upon reading the following detailed description and the appended claims with reference to the accompanying drawings.

### BRIEF DESCRIPTION OF THE DRAWINGS

These and other aspects of the invention will be understood from the description and claims herein, taken together with the drawings showing details of construction and illustrative embodiments, wherein:

FIG. 1 depicts a diagram of the method of using Electron-beam technology to remove recalcitrant organic matter and/or volatile organic compounds from a target water sample or other fluid samples.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

The singular forms “a”, “an”, and “the” include plural referents unless the context clearly dictates otherwise.

Disclosed is an improved method of using Electron-beam technology (or E-beam technology) to remove recalcitrant organic matter and/or volatile organic compounds from a target water sample or other fluid samples. The target water sample is a sample of water taken from any industrial process including, but not limited to, a wastewater treatment system, a drinking water treatment system, a food process water treatment system, or a membrane process water treatment system. The E-beam technology could be replaced by any other high energy source known in the art, such as plasma means, without affecting the overall concept of the invention.

Applicants have discovered that E-beam technology may provide a remediation strategy for recalcitrant organic matter and/or volatile organic compounds. Recalcitrant Chemical Oxygen Demand (COD) substances in industrial wastewater typically comprises, but is not limited to, polyaromatic hydrocarbons, anilines, acrylonitrile, glycol alkyl ethers, oils, tertiary aliphatic alcohols and phenols. Additionally, remediation of volatile organic chemicals (VOC) presents similar challenges as shown by the recalcitrant COD substances and these chemicals are not easily removed from the environment as well. E-beams produced by high energy electron beam accelerators, low energy electron beam accelerators, or other suitable devices as is known in the art, efficiently transfer energy to industrial processes or fluid, driving chemical reactions and doing useful work. Portable E-beam technology is available wherein a filament is heated to produce electrons which are accelerated in a vacuum via an electric field to a faceplate covered with titanium foil. The resultant E-beam enters the treatment space where it can interact with pollutants or contaminants

In one embodiment, organic moieties present in the water may be first sorbed and subsequently desorbed via an energy means, and then destroyed via the E-beam. The organic moieties are typically desorbed by heat or microwave or other suitable energy means as is known in the art. Thus, the concept of treating an organic laden water that may report to a series of sorption means, such as, but not limited to, carbon, to remove problematic organic components is dealt with using the E-beam technology. VOCs may be treated in this way as well, or they may be treated directly without first sorbing and desorbing prior to irradiation.

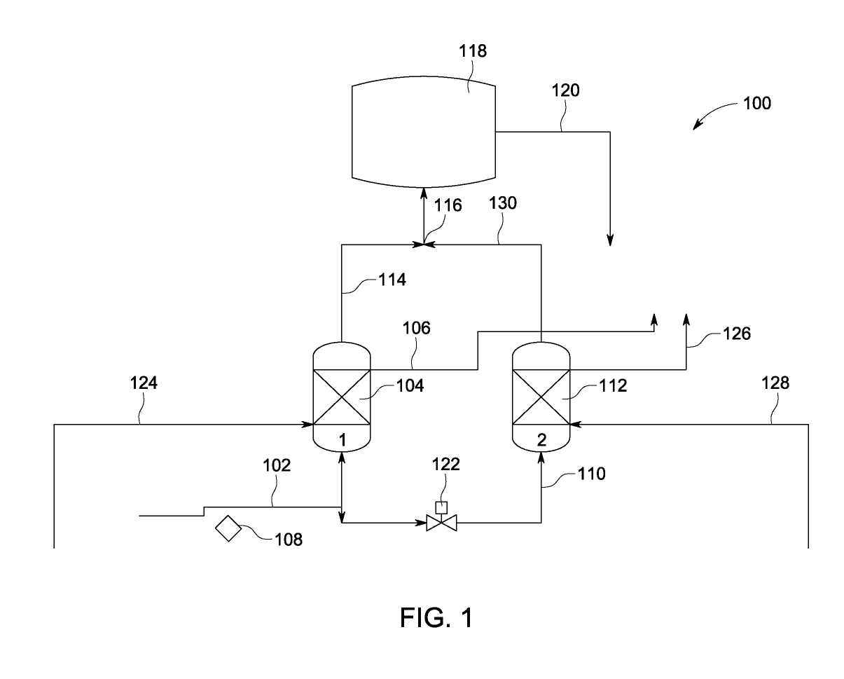

FIG. 1 illustrates the method 100 wherein organic moieties present in the water may be first sorbed and subsequently desorbed, and then destroyed via the E-beam. First, water 102 enters the bottom of vessel #1 104 and contacts the sorbent. The organic moieties are absorbed to saturation levels on a substrate such as carbon. Typical sorbents include, but are not limited to, activated carbons, polymer-modified zeolites, or polymer-modified clays, other suitable sorbents as is known in the art without affecting the overall concept of the present invention. Next, clean water 106 exits vessel #1 104 and reports to process, or reuse/disposal. Control sensor 108 detects saturation or exhaustion of sorption media from vessel #1 104. Control sensor 108 can be based on flow, time or some other parameter to detect saturation or exhaustion of the sorption media. When saturation or exhaustion of the sorption media has been detected in vessel #1 104, control sensor 108 stops flow of water 102 to vessel #1 104 and initiates flow of water 110 to vessel #2 112 via sequencing control valve 122.

At the same time, control sensor 108 then initiates cleaning of vessel #1 104. Vessel #1 104 is regenerated 124 with steam distillation or other means, such as microwave to desorb or blow off the organic contaminants. As vessel #1 104 is desorbing, vessel #2 112 continues to filter the water by contacting the sorbent, and clean water 126 exits vessel #2 112 and reports to process, or reuse/disposal. The desorbed materials 114 from vessel #1 104, now in the vapor state, move through to the common manifold 116 and are treated via an E-beam 118 to destroy organic and inorganic matter. The gas 120 is made to exit the E-beam 118 to atmosphere or scrubber as required. Then, vessel #2 112 reaches saturation and the control sensor 108 again switches flow to vessel #1 104 via the sequencing control valve 122, and vessel #2 112 is regenerated 128 in the same way as vessel #1 104. The desorbed materials 130 from vessel #2 112, now in the vapor state, move through to the common manifold 116 and are treated via an E-beam 118 to destroy organic and inorganic matter.

In some embodiments, the E-beam could be ducted to the vessels so that one E-beam could be suitable for multiple vessels. Additionally, the E-beam typically penetrates approximately five millimeters into the water. Accordingly, when removing recalcitrant organics from bulk water, a low flow or thin film technology would be needed to effect destruction of the recalcitrant organic matter throughout the bulk of the water. Low flow or thin film technology involves exposing thin layers of water to the ionizing radiation for the purpose of sterilization. Further, the layers of water can be recycled back through for further irradiation. Furthermore, other arrangements of the E-beam can be used, such as underflow and topflow treatments, to insure that the bulk of the water has been irradiated, as E-beam penetration into the bulk phase of water is problematic.

Furthermore, by utilizing the sorption/desorption process first and then utilizing an E-beam to destroy organic and inorganic matter, the E-beam does not have to run constantly, hence the power consumption for the Ebeam generator is greatly reduced relative to continuous operation. Additionally, intermittent use of the E-beam alleviates issues related to cooling as well as other operational issues.

Additionally, the E-beam technology can be augmented or enhanced by the use of chemicals. For example, chemicals can be used to enhance the sorption tendency of organics and/or may be used to elute adsorbed recalcitrant materials for subsequent treatment via the E-beam. Furthermore, oxidant chemistry may be incorporated into the treatment to help reduce the required dose of the E-beam and/or relax the need for a thin film arrangement. Using an E-beam in this manner obviates the penetration problem, but imposes a restriction on the technology to those compounds that can be sorbed and desorbed by some sorbent and/or to volatile organic matter directly.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention. Therefore, the technical scope of the present invention encompasses not only those embodiments described above, but also all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal language of the claims.

What is claimed is:

1. A method of removing organic matter from a fluid comprising:
directing the fluid into a first vessel;
sorbing organic matter from the fluid;
desorbing the organic matter in the first vessel using an energy means;
irradiating vapor phase desorbed organic materials from the first vessel with a beam of electrons from an electron beam generator; and
venting treated vapor stream to a scrubber or directly to environment.

2. The method of claim 1, wherein the energy means comprises heat or microwave energy.

3. The method of claim 1, further comprising at least one second vessel that accepts the fluid once the flow of fluid is stopped to the first vessel.

4. The method of claim 3, wherein a control sensor detects saturation of sorption means of the organic matter in the first vessel and stops the flow of fluid to the first vessel.

5. The method of claim 4, wherein the control sensor is time sequenced or flow sequenced.

6. The method of claim 5, wherein a sequencing control valve redirects the flow of the fluid from the first vessel to the at least one second vessel.

7. The method of claim 6, further comprising sorbing organic matter from the fluid in the at least one second vessel while the first vessel is desorbing the organic matter using an energy means.

8. The method of claim 7, further comprising transferring the desorbed organic matter from the first vessel to a common manifold for irradiation.

9. The method of claim 8, wherein the control sensor detects saturation of sorption of the organic matter in the at least one second vessel and stops the flow of fluid to the at least one second vessel.

10. The method of claim 9, wherein the sequencing control valve redirects the flow of the fluid from the at least one second vessel to a regenerated vessel.

11. The method of claim 10, further comprising sorbing organic matter from the fluid in the regenerated vessel while the at least one second vessel is desorbing the organic matter using an energy means.

12. The method of claim 11, further comprising transferring the desorbed organic matter from the at least one second vessel to the common manifold for irradiation.

13. The method of claim 12, wherein the electron beam generator is mounted on the common manifold which receives the desorbed matter from the first vessel and the at least one second vessel.

14. The method of claim 13, wherein the electron beam generator is ducted to the first vessel and the at least one second vessel such that one electron beam generator could be suitable for multiple vessels.

15. The method of claim 14, further comprising recycling a portion of the irradiated fluid back for further irradiation through a recycling passage.

16. The method of claim 1, further comprising utilizing chemicals to enhance sorption tendency of organic matter.

17. The method of claim 1, further comprising utilizing chemicals to elute adsorbed organic matter for subsequent irradiation.

18. The method of claim 1, further comprising utilizing oxidant chemicals to reduce required amount of irradiation.

19. The method of claim 1, wherein the electron beam generator is a high energy electron beam accelerator.

20. The method of claim 1, wherein the sorbent comprises carbon or chemically modified clays or glasses.
